(19) United States
(12) Patent Application Publication
(10) Pub. No.: US 2017/0041430 A1
(43) Pub. Date: Feb. 9, 2017

(54) PRIORITIZING NETWORK TRAFFIC BASED ON RELATIVE IMMINENCE OF USAGE

(71) Applicant: Lenovo Enterprise Solutions (Singapore) Pte. Ltd., Singapore (SG)

(72) Inventors: Milton Cobo, Raleigh, NC (US); Gary D. Cudak, Wake Forest, NC (US); Eric E. Pettersen, Raleigh, NC (US); Luke D. Remis, Raleigh, NC (US)

(21) Appl. No.: 14/818,500

(22) Filed: Aug. 5, 2015

(51) Int. Cl. H04L 29/08

(52) U.S. Cl. CPC H04L 67/322; H04L 67/22; H04L 67/34

(57) ABSTRACT

A method and computer program product for performing the method are provided. The method includes managing network traffic, such as data files and data streams, for a network device, and identifying a context, such as a source address, subject matter, file type, file size, and data streaming rate, associated with each of the network objects. The method further includes obtaining user data associated with the network device, for example a plurality of activities, such as schedule events and historical behavior, and a time associated with each activity. Still further, the method comprises correlating network objects to activities, and altering prioritization of the network objects that are correlated with the activities in response to a current time being within a predetermined time period of the time associated with the one or more activities.

### BACKGROUND

Field of the Invention

The present invention relates to managing network traffic of a network device.

Background of the Related Art

A data network is a telecommunications network that allows any number of interconnected network devices to exchange data, such as messages, commands and data files or streams. Data networks may utilize conductive or optical cables, wireless transceivers, or both. The network devices, such as computers, servers, network switches, and mobile phones, may communicate with each other through direct or indirect connections within the network.

Networks may vary in scope, including local area networks (LANs) and wide area networks (WANs). A typical local area network may be, for example, an Ethernet network. The Internet is a global system of interconnected computers and networks that implement Transmission Control Protocol (TCP) and the Internet Protocol (IP).

Many networks will include a network switch that facilitates the interconnection of numerous network devices, such as nodes or other network switches. A network switch is adapted to receive, process and forward data among the network devices in an efficient manner, for example using a unique media access control (MAC) address for each network device in accordance with the Open Systems Interconnection (OSI) model.

The rate or capacity at which data may be transferred from one network device to another may be referred to as network bandwidth, which may be expressed as a number of data bits per unit of time. The network bandwidth between any two network devices is limited by the hardware installed to handle the data transfer and is typically shared among multiple network devices or even competing applications on a single network device. Accordingly, it is desirable to manage the network traffic in order to make an efficient use of the available network bandwidth.

### BRIEF SUMMARY

One embodiment of the present invention provides a method, comprising managing network traffic for a network device, wherein the network traffic includes a plurality of network objects selected from data files and data streams, and identifying a context associated with each of the network objects, wherein the context is selected from a source address, subject matter, file type, file size, and data streaming rate. The method further comprises obtaining user data associated with the network device, wherein the user data includes a plurality of activities and a time associated with each activity, and wherein the activities are selected from scheduled events and historical behavior. Still further, the method comprises correlating one or more of the network objects to one or more of the activities, and altering prioritization of the one or more of the network objects that is correlated with the one or more of the activities in response to a current time being within a predetermined time period of the time associated with the one or more activities.

Another embodiment of the present invention provides a computer program product comprising a non-transitory computer readable storage medium having program instructions embodied therewith, wherein the program instructions are executable by a processor to cause the processor to perform a method. The method comprises managing network traffic for a network device, wherein the network traffic includes a plurality of network objects selected from data files and data streams, and identifying a context associated with each of the network objects, wherein the context is selected from a source address, subject matter, file type, file size, and data streaming rate. The method further comprises obtaining user data associated with the network device, wherein the user data includes a plurality of activities and a time associated with each activity, and wherein the activities are selected from scheduled events and historical behavior. Still further, the method comprises correlating one or more of the network objects to one or more of the activities, and altering prioritization of the one or more of the network objects that is correlated with the one or more of the activities in response to a current time being within a predetermined time period of the time associated with the one or more activities.

### BRIEF DESCRIPTION OF THE SEVERAL VIEWS OF THE DRAWINGS

FIG. 1 is a system including a diagram of a plurality of network devices in communication over a network.

FIG. 2 is a diagram of a switch.

FIG. 3 is a diagram of memory including various modules implementing embodiments of the present invention.

FIG. 4 is an illustration of a behavior table.

FIG. 5 is an illustration of data from a user calendar.

FIG. 6 is an illustration of a correlation and prioritization table.

FIG. 7 is a graph of prioritization as a function of time for network objects correlated to a scheduled presentation.

FIG. 8 is a flowchart of a method according to one embodiment of the present invention.

FIG. 9 is a diagram of a computer or server.

### DETAILED DESCRIPTION

One embodiment of the present invention provides a method, comprising managing network traffic for a network device, wherein the network traffic includes a plurality of network objects selected from data files and data streams, and identifying a context associated with each of the network objects, wherein the context is selected from a source address, subject matter, file type, file size, and data streaming rate. The method further comprises obtaining user data associated with the network device, wherein the user data includes a plurality of activities and a time associated with each activity, and wherein the activities are selected from scheduled events and historical behavior. Still further, the method comprises correlating one or more of the network objects to one or more of the activities, and altering prioritization of the one or more of the network objects that is correlated with the one or more of the activities in response to a current time being within a predetermined time period of the time associated with the one or more activities.

The methods of the present invention may, without limitation, be implemented in network switches, network adapters, mobile phones, operating system software, computers, and servers. Furthermore, the method may be implemented within a local network device from which the user data is obtained, or a remote network device that must obtain the user data from the local network device. The method may be focused to manage network traffic being downloaded by the network device, network traffic that is being uploaded from the network device, or both.

In one embodiment, the context associated with each of the network objects being transmitted over the network may be identified by reading metadata in a header of each of the network objects. Optionally, the context may be identified by scanning the content of the network objects or otherwise measuring one or more aspect of the network object, such as the file type, file size, and data streaming rate.

As previously stated, the user data includes activities selected from scheduled events and historical behavior. For example, scheduled events may be obtained by querying a calendar stored on the network device. Conversely, the historical behavior may be obtained by monitoring activity associated with the network device over a period of time and storing a record of the activity. The historical behavior may establish a set of norms that describe typical or repeated behavior with varying degrees of reliability. For example, while an individual may not check their email each and every day at the same exact time, if the individual checks their email between 8:00 am and 10:00 am, 4 out of 5 business days, then this may be sufficiently predictable to establish it as a historical behavior. In one option, the user data associated with the network device is stored on the network device.

In another embodiment, correlating one or more of the network objects to one or more of the activities may include performing a lookup in a table of predetermined correlations between a selected context and a selected activity. The table may be set up by an administrator using their own organizational knowledge, or the table may be built using an algorithm that monitors the context on network objects and activities associated with network devices in order to identify correlations there between.

Prioritization of the one or more of the network objects may be altered in various ways. For example, prioritization of a network object may be altered by scheduling the network object for immediate handling or transmission ahead of previously scheduled network objects. As another example, prioritization of a network object may be altered by allocating an increased amount of bandwidth to the network object. Optionally, the increased amount of bandwidth allocated to the network object may be sufficient to complete handling or transmission of the network object before the associated activity begins.

In a further embodiment, aspects of the method may be performed by a remote service provider. For example, the method may further comprise sending the context and the user data to a remote server, the remote server performing the step of correlating one or more of the network objects to one or more of the activities, and the remote server sending a prioritization for the one or more of the network objects to the network device. Accordingly, the step of altering prioritization of the one or more of the network objects may include the network device receiving the prioritization from the remote server and altering prioritization of the one or more of the network object to use to the prioritization received from the remote server.

Another embodiment of the present invention provides a computer program product comprising a non-transitory computer readable storage medium having program instructions embodied therewith, wherein the program instructions are executable by a processor to cause the processor to perform a method. The method comprises managing network traffic for a network device, wherein the network traffic includes a plurality of network objects selected from data files and data streams, and identifying a context associated with each of the network objects, wherein the context is selected from a source address, subject matter, file type, file size, and data streaming rate. The method further comprises obtaining user data associated with the network device, wherein the user data includes a plurality of activities and a time associated with each activity, and wherein the activities are selected from scheduled events and historical behavior. Still further, the method comprises correlating one or more of the network objects to one or more of the activities, and altering prioritization of the one or more of the network objects that is correlated with the one or more of the activities in response to a current time being within a predetermined time period of the time associated with the one or more activities.

The foregoing computer program product may further include program instructions for implementing or initiating any one or more aspects of the methods described herein. Accordingly, a separate description of the methods will not be duplicated in the context of a computer program product.

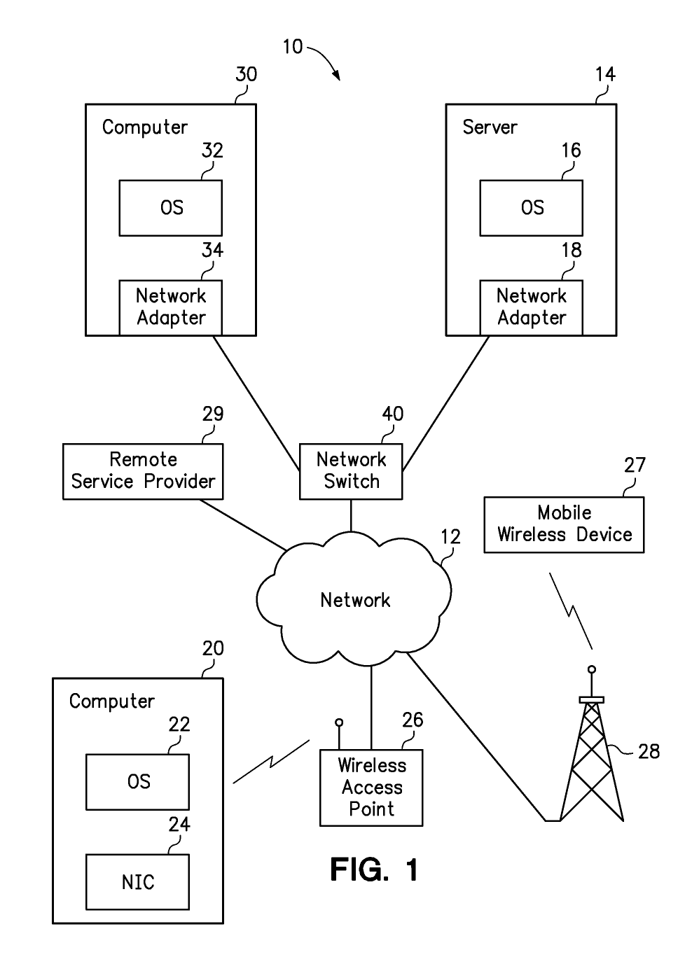

FIG. 1 is a diagram of a system 10 including a plurality of network devices in communication over a network. The network 12 is illustrated as a separate entity, but it should be understood that the network may include any or all of the network devices shown. The system 10 illustrates a network switch 40; a computer 30 with an operating system 32 and network adapter 34; a server 14 with an operating system 16 and network adapter 18; a wireless computer 20 with an operating system 22 and a network interface controller (NIC) 24 in communication with the network via a wireless access point 26; a mobile wireless device 27 in communication with the network via a cell tower 28; and a remote service provider 29. Network objects may be exchanged between these network devices over the relevant interconnections and intermediate network devices. While the computer 30 may referred to as a node or endpoint that sends and receives network objects, the switch 40 is designed to forward network objects from a sending device to a receiving device. The scope of the present invention is not limited to any particular network topology and does not require inclusion of the network switch, network adapter, mobile phone, operating system software, computers, and server set out in FIG. 1. The system 10 is illustrated for the purpose of discussion.

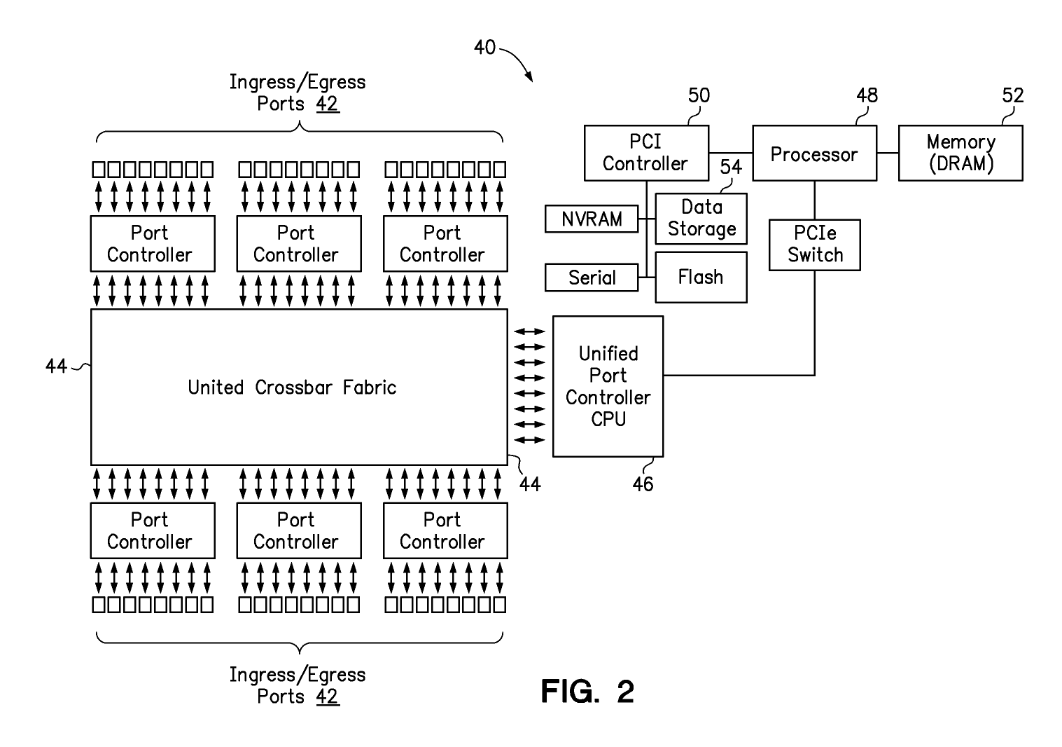

FIG. 2 is a diagram of a switch 40 in accordance with one non-limiting example. The switch 40 includes a plurality of ingress/egress ports 42 coupled to the unified crossbar fabric 44. The unified crossbar fabric 44 is controlled by a unified port controller CPU 46 in accordance with instructions of a processor 48. The processor 48 operates with access to the PCI controller 50 and the memory 52, and controls the unified port controller CPU 46. A computer program product including program instructions may be stored in a non-transitory computer readable storage medium, such as the data storage device 54. During operation, the program instructions may be loaded into the memory 52 and executed by the processor 48 to perform a method according to the embodiments of the present invention.

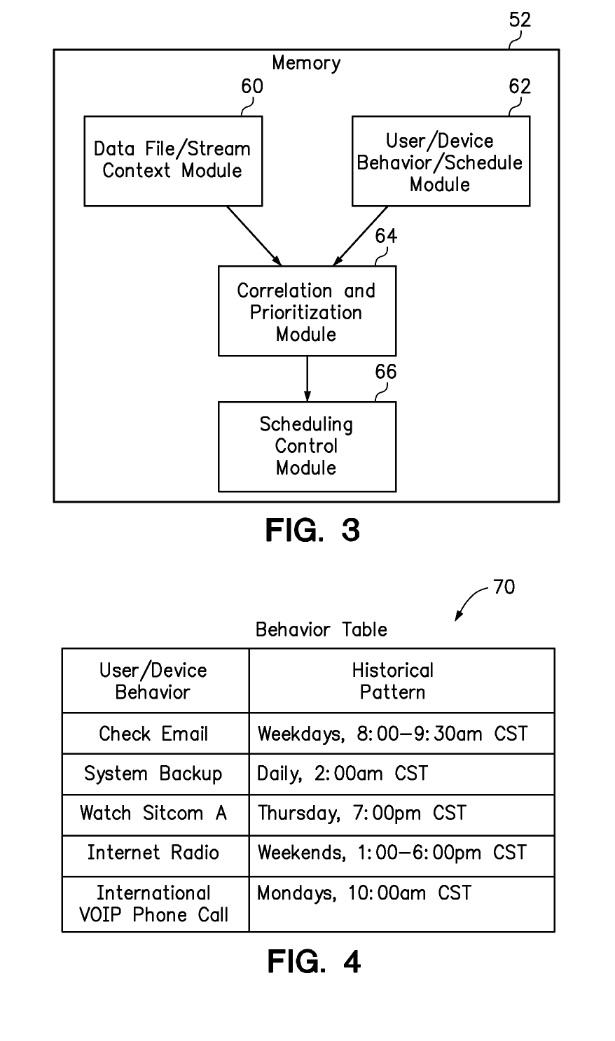

FIG. 3 is a diagram of memory 52 including various modules implementing embodiments of the present invention for managing network traffic for a network device, wherein the network traffic includes a plurality of network objects selected from data files and data streams. A data file or data stream context module 60 includes program instructions for identifying a context associated with each of the network objects, wherein the context is selected from a source address, subject matter, file type, file size, and data streaming rate. A user/device behavior or schedule module 62 includes program instructions for obtaining user data associated with the network device, wherein the user data includes a plurality of activities and a time associated with each activity, and wherein the activities are selected from scheduled events and historical behavior. A correlation and prioritization module 64 includes program instructions for correlating one or more of the network objects to one or more of the activities and altering prioritization of the one or more of the network objects that is correlated with the one or more of the activities in response to a current time being within a predetermined time period of the time associated with the one or more activities. The context identified by the context module 60 and the user data from the user/device behavior or schedule module 62 are provided to the correlation and prioritization module 64, which uses the context and user data to determine a prioritization that is provided to a scheduling control module 66. The scheduling control module 66 is responsible for managing the prioritization of each network object that is being transmitted to, from or through the network device, such as scheduling network objects in a queue and/or allocating the available bandwidth among the network objects.

FIG. 4 is an illustration of a behavior table 70. It should be recognized that the table is an illustrative data structure, and that the same or similar data may be stored in other data structures within the scope of the present invention. The behavior table 70 illustrates one example of the type of user data that might be obtained by monitoring the use of a user's network device over a period of time. The behavior table 70 includes a first column that identifies a user/device behavior and a second column that identifies an observed historical pattern associated with each user/device behavior. For example, the behavior table 70 shows that a user often checks email on weekdays between 8:00 and 9:30 am central standard time (CST), that the network device performs system backups at 2:00 am daily, that the user often watches Sitcom A on Thursdays at 7:00 pm CST, that the user often listens to internet radio on weekends between 1:00 and 6:00 pm CST, and that the user makes an international voice over internet protocol (VOIP) on Mondays at 10:00 am CST.

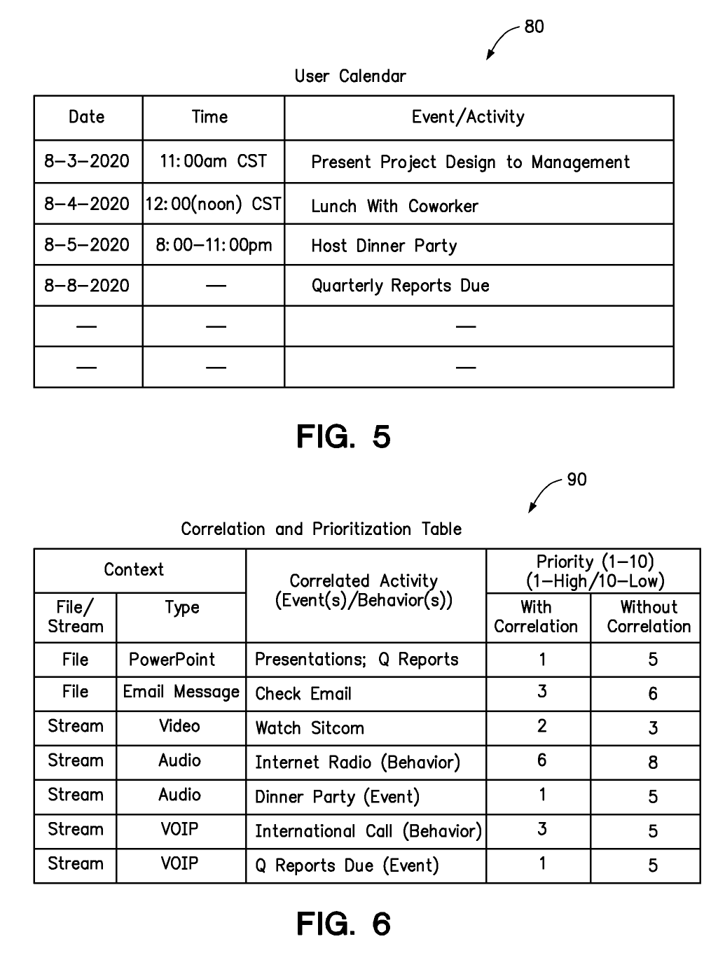

FIG. 5 is an illustration of data from a user calendar 80. Such data may be obtained by querying a user's network device. The data may represent every entry of a calendar or only those entries in a relevant time frame. In the illustration, the user calendar 80 includes columns for a date, a time and an event/activity description. For example, the calendar has an entry for 8-3-2010 at 11:00 am CST to “Present Project Design to Management”, an entry for 8-4-2020 at 12:00 (noon) CST to have “Lunch With Coworker”, an entry for 8-5-2020 from 8:00-11:00 pm to “Host Dinner Party”, and an entry for 8-8-2020 (no particular time) indicating that “Quarterly Reports Due.”

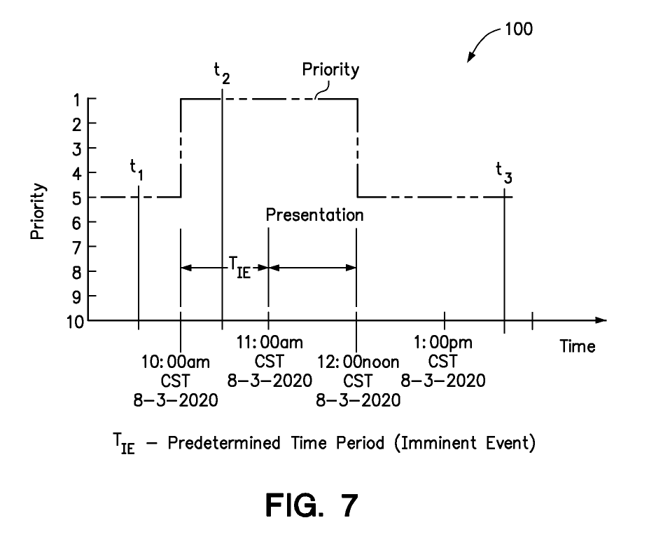

FIG. 6 is an illustration of a correlation and prioritization table 90. It should be recognized that the table is an illustrative data structure, and that the same or similar data may be stored in other data structures within the scope of the present invention. In this non-limiting illustration, the correlation and prioritization table 90 includes columns for identifying the context (i.e., file/stream, type) of a plurality of network objects that are being transmitted relative to a particular network device, a correlated activity (i.e., event(s)/behavior(s)), and a corresponding priority for the network object with or without the correlation being present. For example, the first record of the table 90 indicates that if a network device (i.e, the network adapter of a user's computer) is downloading a PowerPoint file correlated to a presentation or a quarterly report due date on the user's calendar, then the priority of that download would be automatically altered from a “5” (wherein “1” is high priority and “10” is low priority) to a “1” (i.e., the highest priority). Accordingly, the PowerPoint file might be placed at the top of a queue of network objects and might be allocated additional bandwidth, for example to assure that the file is completely downloaded prior to the start of the presentation at 11:00 am CST on 8-3-2020. This example is continued in reference to FIG. 7.

FIG. 7 is a graph 100 of prioritization (on the vertical axis) as a function of time (on the horizontal axis) for a network object (i.e., a PowerPoint file) correlated to a scheduled presentation. Consistent with the user calendar 80 of FIG. 5, the user has a presentation scheduled for 11:00 am CST on 8-3-2020. In this example, the method is using a predetermined time period (T_{IE}; time before an imminent event/activity) of one hour. Accordingly, if the network device detects transmission of a PowerPoint file in the one hour time period prior to or during the scheduled presentation (such as at time t₂), then downloading or uploading of that PowerPoint file will be given a priority of “1”. However, if the same PowerPoint file was being downloaded or uploaded more than the one hour (T_{IE}) prior to the presentation (such as at time t₁) or after the presentation (such as at time t₃), then downloading or uploading of that PowerPoint file will be given a priority of “5” (see dashed line representing priority). It should be appreciated that while the example shows a single step of the priority from “5” to “1”, the priority could be increased gradually or in multiple steps leading up to the beginning of the presentation.

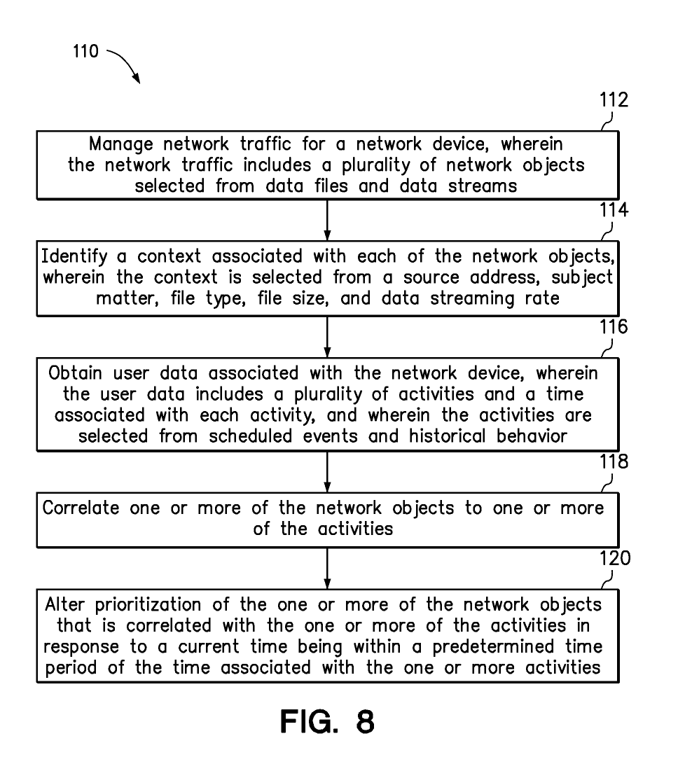

FIG. 8 is a flowchart of a method 110 according to one embodiment of the present invention. In step 112, the method manages network traffic for a network device, wherein the network traffic includes a plurality of network objects selected from data files and data streams. In step 114, the method identifies a context associated with each of the network objects, wherein the context is selected from a source address, subject matter, file type, file size, and data streaming rate. User data associated with the network device is obtained in step 116, wherein the user data includes a plurality of activities and a time associated with each activity, and wherein the activities are selected from scheduled events and historical behavior. Then, in step 118, the method includes correlating one or more of the network objects to one or more of the activities. Accordingly, step 120 of the method alters prioritization of the one or more of the network objects that is correlated with the one or more of the activities in response to a current time being within a predetermined time period of the time associated with the one or more activities.

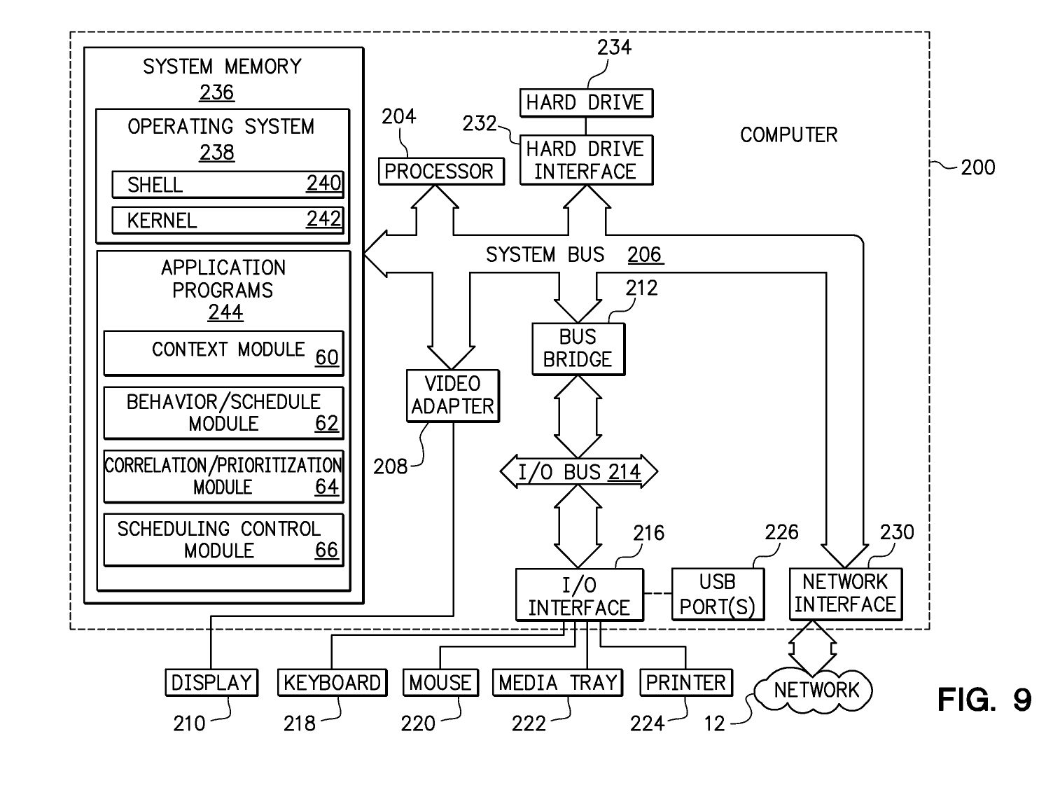

FIG. 9 is a diagram of a computer or server 200 that is representative of the computers 20, 30, server 14, mobile wireless device 27, and remote service provider 29 shown in FIG. 1 and capable of implementing the methods of the present invention in an operating system, a network adapter, or network interface controller.

The computer 200 includes a processor unit 204 that is coupled to a system bus 206. The processor unit 204 may utilize one or more processors, each of which has one or more processor cores. A video adapter 208, which drives/supports a display 210, is also coupled to system bus 206. The system bus 206 is coupled via a bus bridge 212 to an input/output (I/O) bus 214. An I/O interface 216 is coupled to I/O bus 214. The I/O interface 216 affords communication with various I/O devices, including a keyboard 218, a mouse 220, a media tray 222 (which may include storage devices such as CD-ROM drives, multi-media interfaces, etc.), a printer 224, and USB port(s) 226. As depicted, the computer 200 is able to communicate with other network devices via the network 12 using a network adapter or network interface controller 230.

A hard drive interface 232 is also coupled to the system bus 206. The hard drive interface 232 interfaces with a hard drive 234. In a preferred embodiment, the hard drive 234 communicates with system memory 236, which is also coupled to the system bus 206. System memory is defined as a lowest level of volatile memory in the computer 200. This volatile memory includes additional higher levels of volatile memory (not shown), including, but not limited to, cache memory, registers and buffers. Data that populates the system memory 236 includes the operating system (OS) 238 and application programs 244.

The operating system 238 includes a shell 240 for providing transparent user access to resources such as application programs 244. Generally, the shell 240 is a program that provides an interpreter and an interface between the user and the operating system. More specifically, the shell 240 executes commands that are entered into a command line user interface or from a file. Thus, the shell 240, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while the shell 240 is a text-based, line-oriented user interface, the present invention will equally well support other user interface modes, such as graphical, voice, gestural, etc.

As depicted, the operating system 238 also includes the kernel 242, which includes lower levels of functionality for the operating system 238, including providing essential services required by other parts of the operating system 238 and application programs 244, including memory management, process and task management, disk management, and mouse and keyboard management. The application programs 244 in the system memory of the computer 200 may include, without limitation, the data file or stream context module 60, the user/device behavior or schedule module 62, the correlation and prioritization module 64, and a scheduling control module 66. Alternatively, the four modules 60, 62, 64, 66, or other embodiments of the present invention, may be implemented within the operating system 238.

The hardware elements depicted in the computer 200 are not intended to be exhaustive, but rather are representative. For instance, the computer 200 may include alternate memory storage devices such as magnetic cassettes, digital versatile disks (DVDs), Bernoulli cartridges, and the like. These and other variations are intended to be within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
managing network traffic for a network device, wherein the network traffic includes a plurality of network objects selected from data files and data streams;
identifying a context associated with each of the network objects, wherein the context is selected from a source address, subject matter, file type, file size, and data streaming rate;
obtaining user data associated with the network device, wherein the user data includes a plurality of activities and a time associated with each activity, and wherein the activities are selected from scheduled events and historical behavior;
correlating one or more of the network objects to one or more of the activities; and
altering prioritization of the one or more of the network objects that is correlated with the one or more of the activities in response to a current time being within a predetermined time period of the time associated with the one or more activities.

2. The method of claim 1, wherein the network traffic being managed for the network device includes downloads and uploads.

3. The method of claim 1, wherein identifying the context associated with each of the network objects includes reading metadata in a header of each of the network objects.

4. The method of claim 1, wherein the historical behavior is obtained by monitoring activity associated with the network device and storing a record of the activity.

5. The method of claim 1, wherein the scheduled events are obtained by querying a calendar stored on the network device.

6. The method of claim 1, wherein the user data associated with the network device is stored on the network device.

7. The method of claim 1, wherein correlating one or more of the network objects to one or more of the activities includes performing a lookup in a table of predetermined correlations between a selected context and a selected activity.

8. The method of claim 1, wherein altering prioritization of the one or more of the network objects includes scheduling the one or more of the network objects for immediate handling ahead of previously scheduled network objects.

9. The method of claim 1, wherein altering prioritization of the one or more of the network objects includes allocating an increased amount of bandwidth to the one or more of the network objects.

10. The method of claim 1, wherein the increased amount of bandwidth allocated to the one or more of the network objects is sufficient to complete handling of one or more of the network objects before the associated activity.

11. The method of claim 1, further comprising:
sending the context and the user data to a remote server;
the remote server performing the step of correlating one or more of the network objects to one or more of the activities; and
the remote server sending a prioritization for the one or more of the network objects to the network device, wherein the step of altering prioritization of the one or more of the network objects includes the network device receiving the prioritization from the remote server and altering prioritization of the one or more of the network object to use to the prioritization received from the remote server.

12. A computer program product comprising a non-transitory computer readable storage medium having program instructions embodied therewith, the program instructions executable by a processor to cause the processor to perform a method comprising:
managing network traffic for a network device, wherein the network traffic includes a plurality of network objects selected from data files and data streams;
identifying a context associated with each of the network objects, wherein the context is selected from a source address, subject matter, file type, file size, and data streaming rate;
obtaining user data associated with the network device, wherein the user data includes a plurality of activities and a time associated with each activity, and wherein the activities are selected from scheduled events and historical behavior;
correlating one or more of the network objects to one or more of the activities; and
altering prioritization of the one or more of the network objects that is correlated with the one or more of the activities in response to a current time being within a predetermined time period of the time associated with the one or more activities.

13. The computer program product of claim 12, wherein identifying the context associated with each of the network objects includes reading metadata in a header of each of the network objects.

14. The computer program product of claim 12, wherein the historical behavior is obtained by monitoring activity associated with the network device and storing a record of the activity.

15. The computer program product of claim 12, wherein the scheduled events are obtained by querying a calendar stored on the network device.

16. The computer program product of claim 12, wherein correlating one or more of the network objects to one or more of the activities includes performing a lookup in a table of predetermined correlations between a selected context and a selected activity.

17. The computer program product of claim 12, wherein altering prioritization of the one or more of the network objects includes scheduling the one or more of the network objects for immediate handling ahead of previously scheduled network objects.

18. The computer program product of claim 12, wherein altering prioritization of the one or more of the network objects includes allocating an increased amount of bandwidth to the one or more of the network objects.

19. The computer program product of claim 1, wherein the increased amount of bandwidth allocated to the one or more of the network objects is sufficient to complete handling of one or more of the network objects before the associated activity.

20. The computer program product of claim 1, the method further comprising:
sending the context and the user data to a remote server;
the remote server performing the step of correlating one or more of the network objects to one or more of the activities; and
the remote server sending a prioritization for the one or more of the network objects to the network device, wherein the step of altering prioritization of the one or more of the network objects includes the network device receiving the prioritization from the remote server and altering prioritization of the one or more of the network object to use to the prioritization received from the remote server.
